(19) United States
(12) Patent Application Publication
(10) Pub. No.: US 2005/0030437 A1
(43) Pub. Date: Feb. 10, 2005

(54) Dream maker

(76) Inventor: Rika Ishida, Tucson, AZ (US)

Correspondence Address: RIKA ISHIDA, 4100 E. 29th St, # 11212, TUCSON, AZ, 85711, US

(21) Appl. No.: 10/313,710

(22) Filed: Jun. 24, 2003

(51) Int. Cl. H04N 5/72

(52) U.S. Cl. 348/832

(57) ABSTRACT

“Dream Maker” has lenses inside to adjust the screen from TV to outside wall or bigger screen clear showing or size of emphasizing to new screen (wall or bigger screen) in the dark room. And the attachment place from TV screen is by rubber or heavy dark fabric to cover not to have any light in to make the screen clearer color.

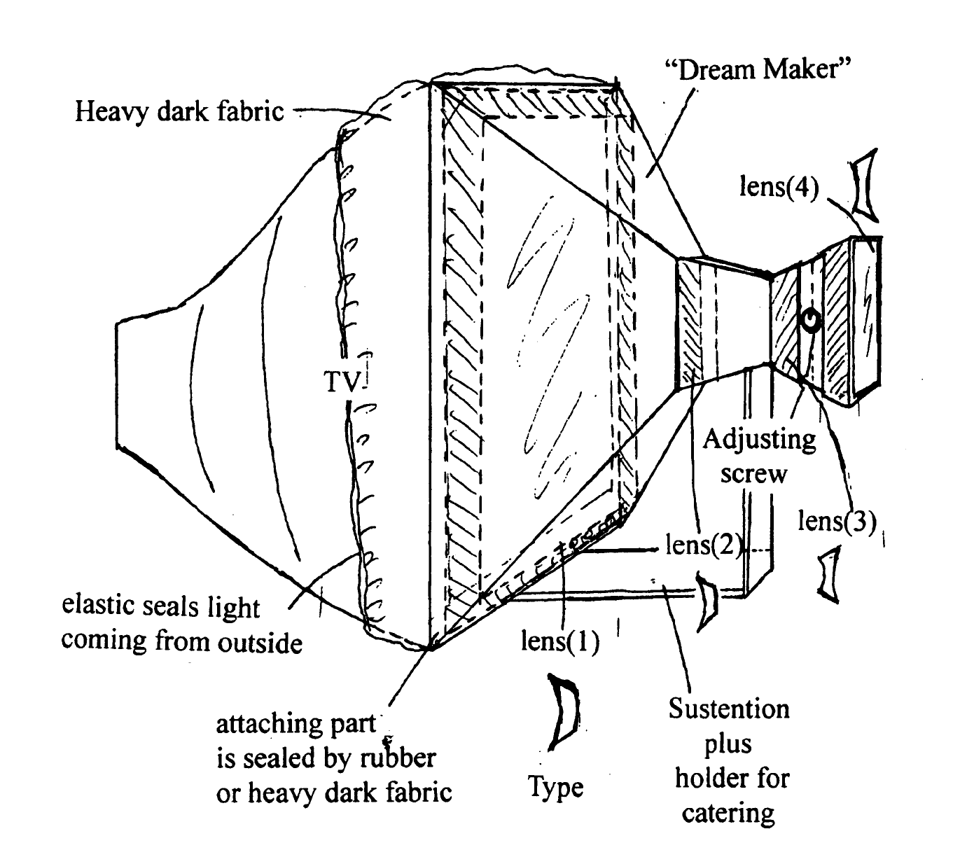

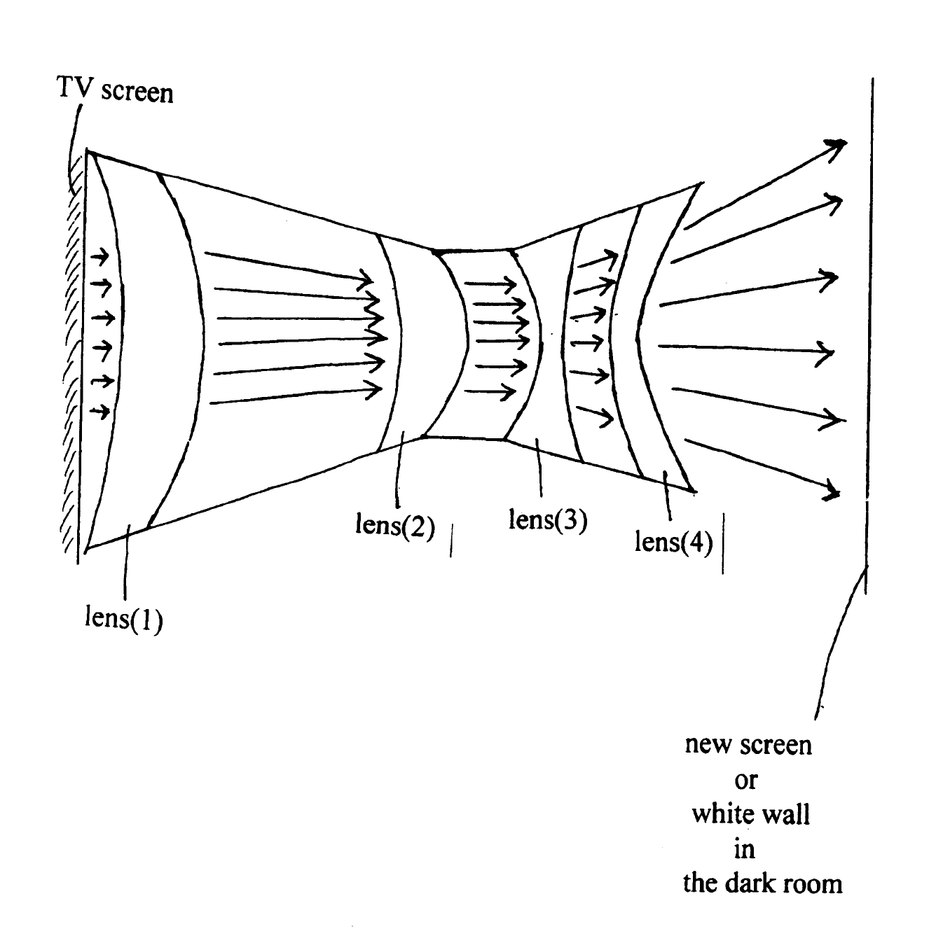

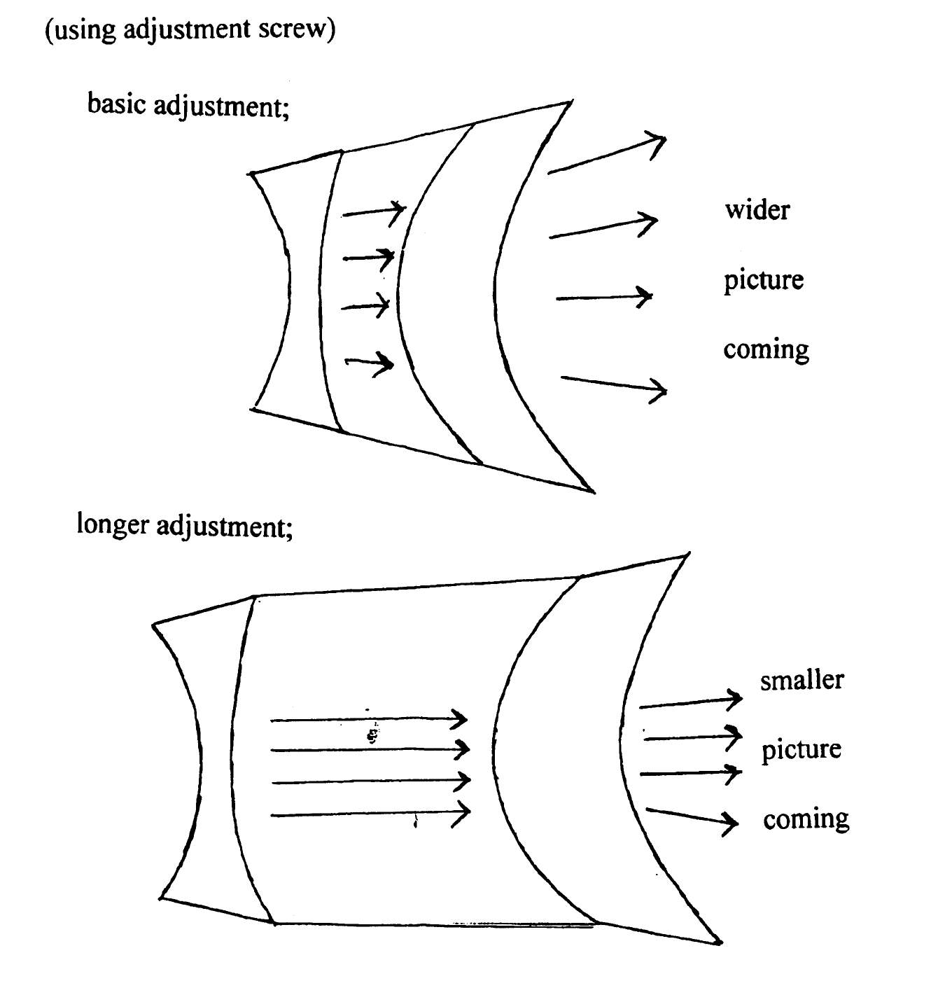

“Dream Maker” has lenses inside to adjust the screen from TV to outside wall or bigger screen clear showing or size of emphasizing to new screen (wall or bigger screen) in the dark room.

And the attachment place from TV screen is by rubber or heavy dark fabric to cover not to have any light in to make the screen clearer color.

1. This is an accessory which attach to the TV screen to make the vision emphasize to the white screen or wall in the dark room to make own room theater at home. This invention is named “Dream Maker”.
